(19) United States
(12) Patent Application Publication
(10) Pub. No.: US 2010/0282828 A1
(43) Pub. Date: Nov. 11, 2010

(54) CARTON WITH MULTIPLE COMPARTMENTS

(76) Inventor: Bradley J. Burke, Glendale Heights, IL (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/775,758

(22) Filed: May 7, 2010

Related U.S. Application Data
(60) Provisional application No. 61/215,767, filed on May 8, 2009.

(51) Int. Cl. B65D 25/04; B31B 1/74; B32B 1/02

(52) U.S. Cl. 229/120.02; 493/52; 493/84; 428/34.2

(57) ABSTRACT

A carton for holding a plurality of articles. The carton comprises a plurality of panels at least partially enclosing an interior space of the carton. The plurality of panels comprises a front panel, a back panel, and at least two side panels. The carton comprises a liner at least partially attached to an interior surface of the carton. The carton comprises at least two compartments that are separated by at least a portion of the liner.

### CROSS-REFERENCE TO RELATED APPLICATIONS

This application claims the benefit of U.S. Provisional Patent Application No. 61/215,767, filed May 8, 2009.

### INCORPORATION BY REFERENCE

U.S. Provisional Patent Application No. 61/215,767, which was filed on May 8, 2009, is hereby incorporated by reference for all purposes as if presented herein in its entirety.

### BACKGROUND OF THE DISCLOSURE

The present disclosure relates to packages or cartons for holding and carrying articles, and more specifically, to a carton having multiple compartments for holding articles.

### SUMMARY OF THE DISCLOSURE

In general, one aspect of the disclosure is generally directed to a carton for holding a plurality of articles. The carton comprises a plurality of panels that at least partially form an interior of the carton. The plurality of panels comprises a front panel, a back panel, and at least two side panels. The carton comprises a liner at least partially attached to an interior surface of the carton. The carton comprises at least two compartments that are separated by at least a portion of the liner.

In another aspect, the disclosure is generally directed to a blank for forming a carton for containing a plurality of articles. The blank comprises a plurality of panels comprising a front panel, a back panel, and at least two side panels. The blank further comprises a liner at least partially attached to an interior surface of the blank for at least partially forming at least two compartments that are separated by at least a portion of the liner when the blank is formed into the carton.

In another aspect, the disclosure is generally directed to a method of forming a carton from a blank. The method comprises obtaining a blank comprising a plurality of panels comprising a front panel, a back panel, and at least two side panels, and a liner at least partially attached to an interior surface of the blank. The method further comprises forming a divider that separates at least two compartments of the carton. The divider comprises at least a portion of the liner.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is an exterior plan view of a carton blank used to form a carton in accordance with a first embodiment of the disclosure.

FIGS. 2-5 are perspective views showing stages of the assembly of the carton from the blank of FIG. 1.

FIGS. 6A and 6B are perspective views showing the partially-assembled carton in a tubular form.

FIG. 7 is a perspective view showing the assembled carton in accordance with a first embodiment of the disclosure.

FIG. 8 is an exterior plan view of a carton blank used to form a carton in accordance with a second embodiment of the disclosure.

FIGS. 9-11 are perspective views showing stages of the assembly of the carton from the blank of FIG. 8.

FIG. 12 is a perspective view showing the partially-assembled carton in a tubular form.

FIGS. 13A and 13B are perspective views of an end of the tubular form of FIG. 12.

FIG. 14 is an exterior plan view of a carton blank used to form a carton in accordance with a third embodiment of the disclosure.

Corresponding parts are designated by corresponding reference numbers throughout the drawings.

### DETAILED DESCRIPTION OF THE EXEMPLARY EMBODIMENTS

Cartons or packages according to the present disclosure can accommodate articles of numerous different shapes. For the purpose of illustration and not for the purpose of limiting the scope of the disclosure, the following detailed description describes articles at least partially disposed within the carton embodiments. In this specification, the terms “lower,” “bottom,” “upper”, “top”, “front”, and “back” indicate orientations determined in relation to fully erected cartons. In one embodiment, the articles held in the carton can be food products, but the articles could be other nonfood products without departing from the disclosure.

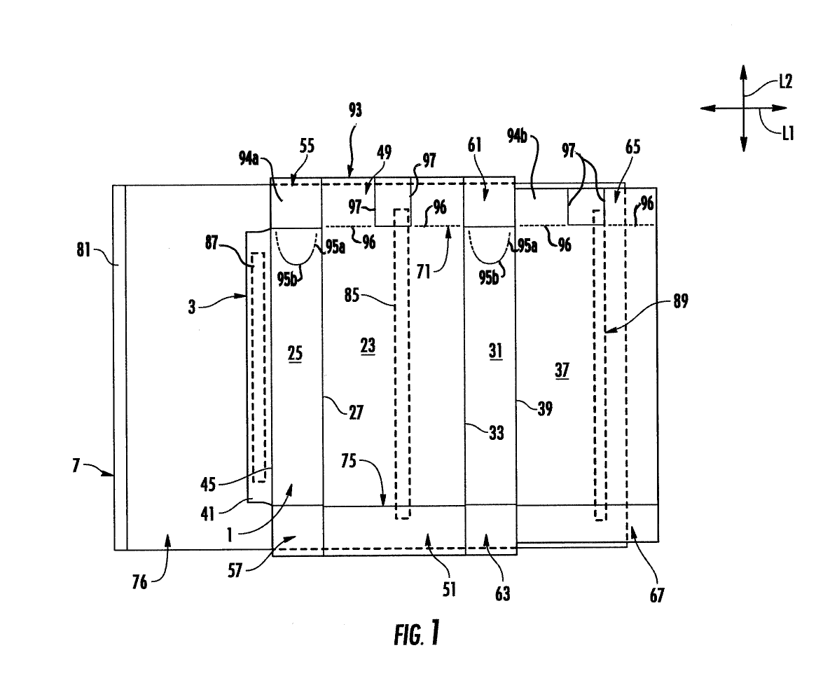

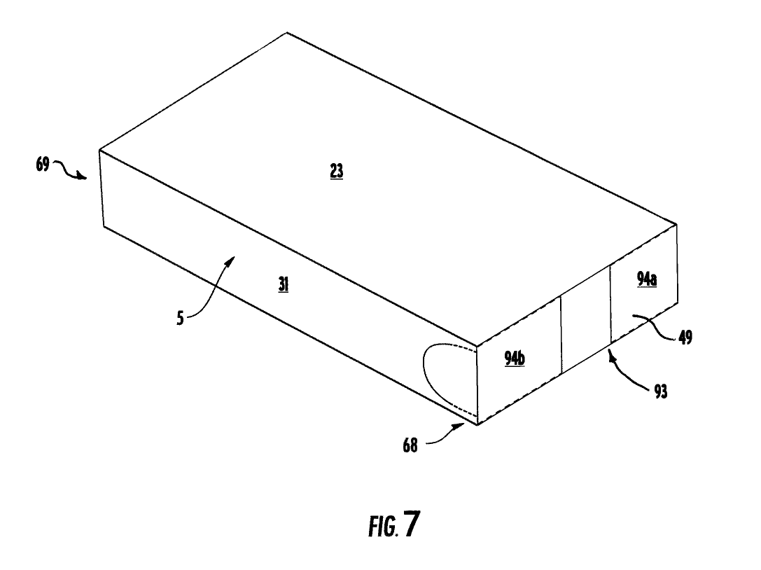

FIG. 1 is a plan view of an exterior surface 1 of a carton blank 3 used to form a carton 5 (FIG. 7) of one embodiment of the disclosure. The carton 5 includes a liner 7 that is in contact with an interior surface 9 of the blank 3. The carton 5 can have multiple compartments (e.g., two) 11, 13 that can be used to hold articles (not shown) such as a plurality of food products (e.g., candy, crackers, popcorn, or any other food product) or nonfood products (grass seed, fertilizer, detergent, or any other nonfood product), or any other article or product. The articles held in each compartment 11, 13 can be complimentary products (e.g., peanut butter and chocolate candy, cheese and crackers, grass seed and fertilizer, etc.) that are marketed together in a single package but are kept in the separate compartments until removed by the consumer. The liner 7 maintains freshness and quality of the products and forms a divider 15 that separates the two compartments 11, 13. The carton 5 can include various dispensing features and various handle features without departing from the disclosure.

The blank 3 has a longitudinal axis L1 extending generally in the direction of the length of the blank and a lateral axis L2 extending generally in the direction of the width of the blank. The blank 3 includes a front panel 23 foldably connected to a first side panel 25 at a lateral fold line 27. A second side panel 31 is foldably connected to the front panel 23 at a lateral fold line 33. A back panel 37 is foldably connected to second side panel 31 at a lateral fold line 39. An attachment flap 41 is foldably connected to the first side panel 25 at a lateral fold line 45.

In the illustrated embodiment, the front panel 23 includes two end flaps 49, 51 foldably connected to opposite ends of the front panel. The first side panel 25 has two end flaps 55, 57 foldably connected to opposite ends of the first side panel. The second side panel 31 has two end flaps 61, 63 foldably connected to opposite ends of the second side panel. The back panel 37 has two end flaps 65, 67 foldably connected to opposite ends of the back panel. When the carton 5 is erected, the end flaps 49, 55, 61, 65 close a first (e.g., top) end 68 of the carton, and the end flaps 51, 57, 63, 67 close a second (e.g., bottom) end 69 of the carton. In accordance with an alternative embodiment of the present disclosure, different panel and flap arrangements can be used for closing the carton 5.

The end flaps 49, 55, 61, 65 extend along a first marginal area of the blank 3, and are foldably connected at a first longitudinal fold line 71 that extends along the length of the blank. The end flaps 51, 57, 63, 67 extend along a second marginal area of the blank 3, and are foldably connected at a second longitudinal fold line 75 that extends along the length of the blank. The longitudinal fold lines 71, 75 may be, for example, substantially straight, or offset at one or more locations to account for blank thickness or for other factors. The end flaps 49, 55, 61, 65, 51, 57, 63, 67 can be alternatively shaped, arranged, positioned, and/or omitted without departing from the disclosure.

In the illustrated embodiment, the liner 7 overlays the interior surface 9 of the blank 3. The liner 7 can be composed of any suitable material which is relatively flexible and relatively fluid impervious. The liner 7 can comprise plastics such as polyethylene, polypropylene, polyethylene terephthalate, polystyrene, poly vinyl chloride, or any other suitable material. Alternatively, the liner 7 could comprise a fluid pervious material without departing from the scope of the disclosure. An optional metallization layer can be deposited on the inner surface of the liner 7 to further increase the barrier properties of the liner 7. The metallization layer may be provided on a surface of the liner 7 by vapor deposition and can be an aluminum layer. Alternatively, the liner 7 could have a metallization layer on its outer surface without departing from the scope of the disclosure.

In the illustrated embodiment, the blank 3 can comprise any material which is relatively rigid such as paperboard, clay-coated paperboard, Kraft lined paperboard, double Kraft lined paperboard, or any other suitable material.

The blank 3, carton 5, and liner 7 could have various properties and could be formed by various methods, processes, forming machines, and apparatus disclosed in the following U.S. patents which are incorporated by reference herein for all purposes: U.S. Pat. No.5,632,402; 5,632,404; 5,667,467; 5,746,871; 5,783,030; 5,794,811; 5,794,812; 5,857,614; 5,918,799; 6,332,488; 6,352,096; 6,386,438; 6,676,583; 6,796,930; 6,854,639; 6,889,892; 7,036,714; 7,210,612; and 7,241,254.

The bank 3 can by formed into the carton 5 and loaded with articles by a suitable packaging system (not shown). The packaging system can comprise different stations, modules, or components, such as a carton forming station, a wrapping station, a pick and place station, a closing or sealing station, or other features and aspects for printing, cutting, scoring, bonding, gluing, etc. or any other suitable station or components.

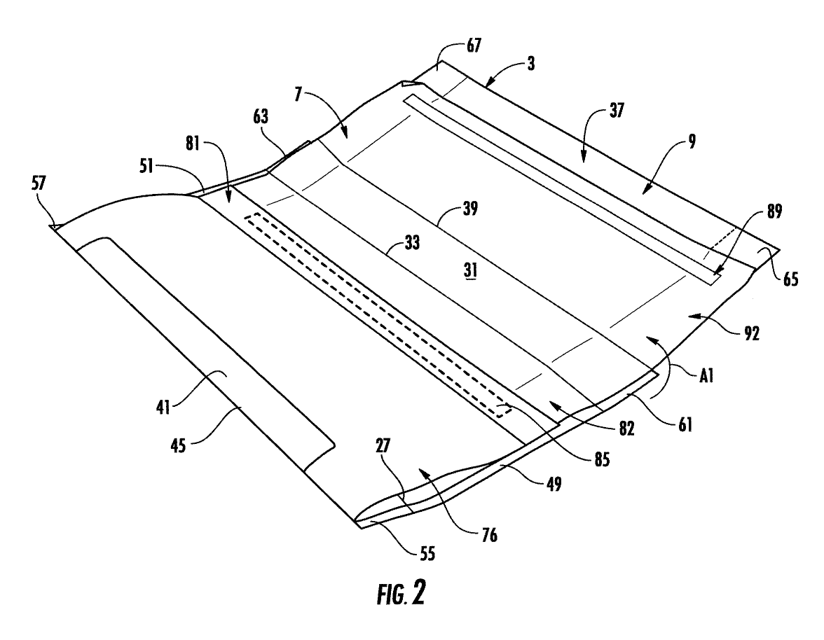

As shown in FIGS. 2-7, and described in the following in accordance with one acceptable example, the carton 5 is formed from the blank 3, by first overlaying the interior surface 9 of the blank with the liner 7. The liner 7 can be selectively attached to the blank 3 by adhesive, such as glue, or other attachment methods such as heat sealing, ultrasonic welding, etc. As shown in FIG. 2, the attachment flap 41 can be secured to the liner 7. The attachment flap 41 and a portion 76 of the liner 7 extending beyond the attachment flap are folded over the first side panel 25 and the front panel 23 at fold line 45. An edge margin 81 of the liner 7 is attached to a portion 82 of the liner covering the front panel 23 at an attachment region 85 (FIG. 1).

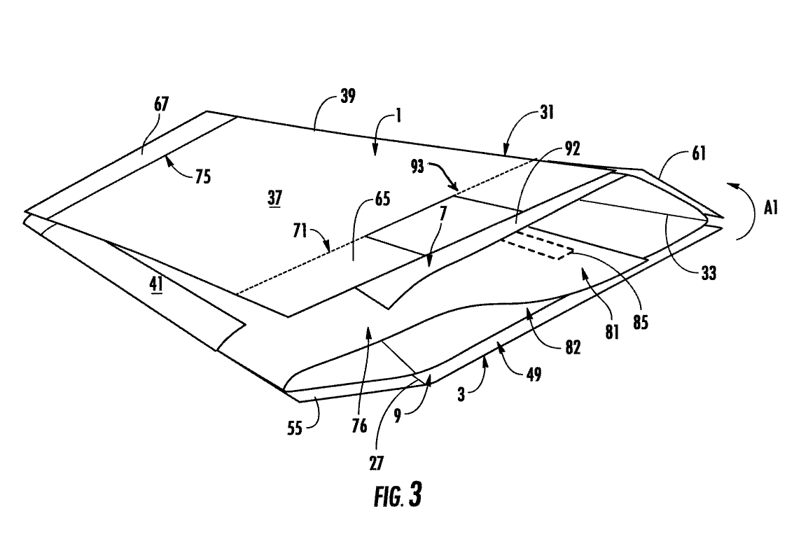

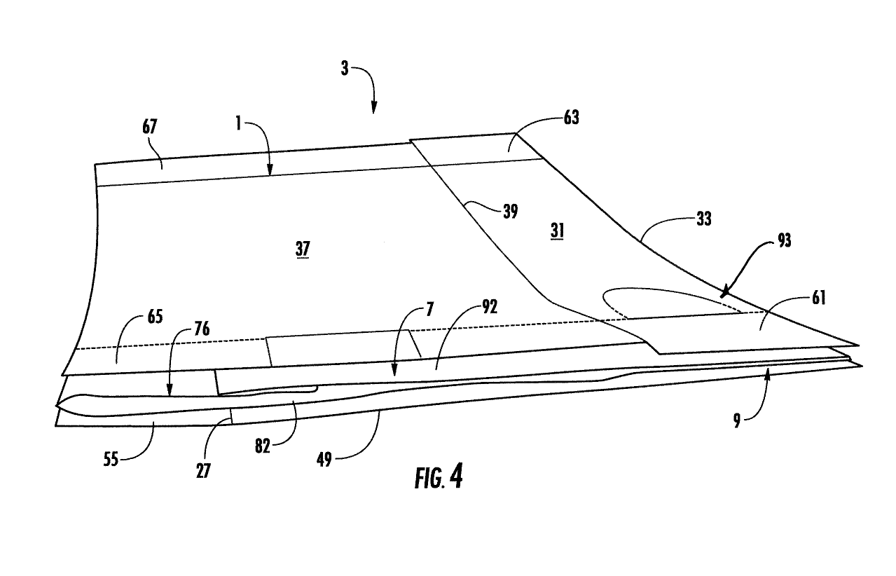

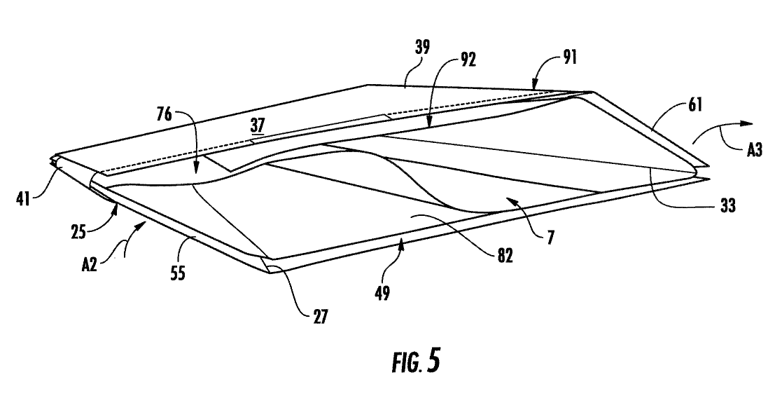

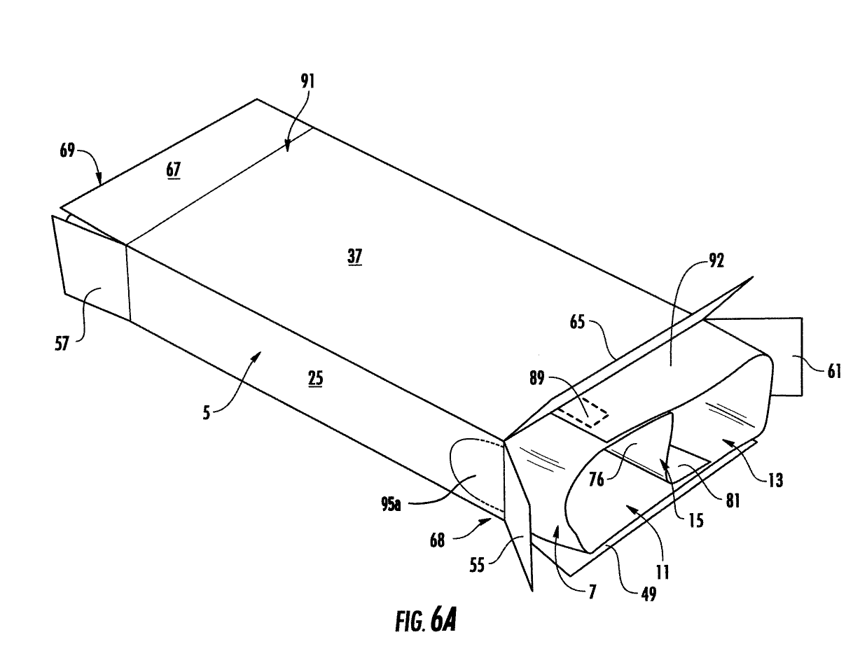

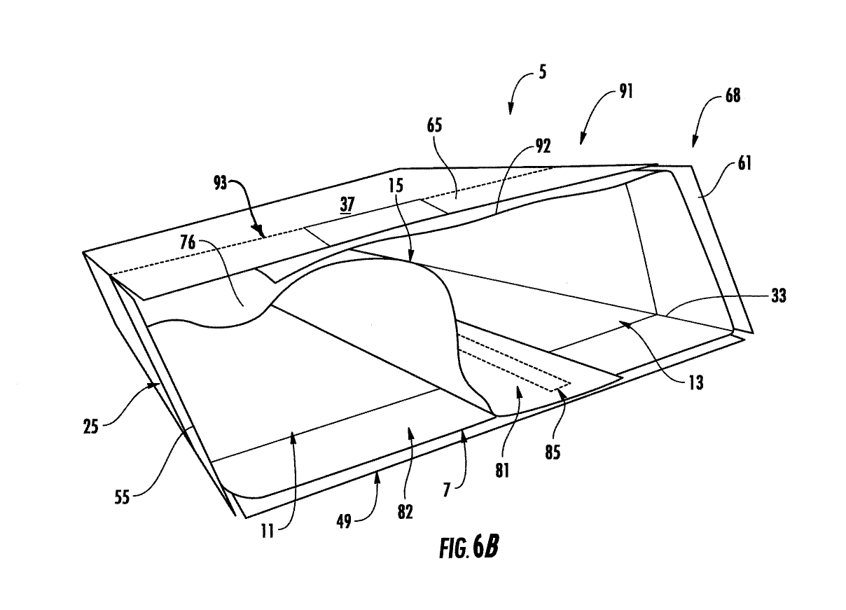

In one embodiment, the bottom panel 37 and the second side panel 31 are folded about fold line 33, generally in the direction of arrow Al (FIGS. 2 and 3) to the position of FIG. 4, wherein the bottom panel and the second side panel are in face-to-face relationship with the folded-over attachment flap 41, the first side panel 25, and the front panel 23. The inner surface 9 of the back panel 37 can be secured to the exterior surface of the attachment flap 41 at an attachment region 87. The liner 7 can include an attachment region 89 (FIG. 1) on a portion 92 of the liner that overlays the back panel 37. The attachment region 89 indicates the attachment location of the portion 92 of the liner overlapping the back panel 37 and the portion 76 of the liner that extends beyond the attachment flap 41 (FIG. 6A). From the position of FIG. 4, the first side panel 25 and the second side panel 31 are positioned to extend between the spaced-apart front panel 23 and back panel 37 to form a generally tubular structure 91 (FIGS. 6A and 6B). The first side panel 25 can be upwardly folded about fold line 27, generally in the direction of arrow A2 (FIG. 5) and the second side panel 31 can be upwardly folded about fold line 33, generally in the direction of arrow A3 (FIG. 5).

As shown in FIGS. 6A and 6B, the divider 15 extends between the front panel 23 and the back panel 37 to form the two compartments 11, 13 of the carton 5. In the first embodiment, the divider 15 comprises a single layer of the liner 7 that extends between the attachment region 89 on the back panel 37 and the attachment region 85 on the front panel 23. In alternative embodiments, the divider 15 could be otherwise configured (e.g., to include one or more portions of the carton 5, to include multiple layers of the liner 7, etc.).

As shown in FIG. 7, the ends 68, 69 of the open carton 5 can be closed by respectively folding and at least partially overlapping the end flaps 49, 55, 61, 65, 51, 57, 63, 67 at the respective top and bottom ends.

The carton 5 can be loaded with articles (e.g., food products, nonfood products, etc.) after one of the ends 68, 69 is closed. The other of the ends 68, 69 can be closed after the carton is loaded. Alternatively, the carton 5 can be loaded with articles by other by other methods.

In the illustrated embodiment, the carton 5 can include an opening feature such as a dispenser 93 (FIGS. 1 and 7) with a tear pattern defining dispenser panels 94a, 94b in the end flaps 49, 65 and the side panels 25, 31. The tear pattern includes tear lines 95a and cut line 95b extending from the longitudinal fold line 71 in the side panels 25, 31, and tear lines 96 extending along portions of the fold line 71 where the end flaps 49, 65 are connected to the respective front panel 23 and back panel 37. The tear lines 96 terminate at fold lines 97 extending laterally in the end flaps 49, 65. The dispenser 93 can be opened after the carton 5 is formed by pushing the dispenser panels 94a, 94b inwardly to separate the dispenser panels from the respective side panels 25, 31 at the tear lines 95a, pulling the dispenser panels outwardly to separate the dispenser panels from the front and back panels 23, 37 at the tear lines 96, and folding the dispenser panels over the lateral fold lines 97. Each of the dispenser panels 94a, 94b can be opened individually so that the contents of the compartments 11, 13 can be accessed selectively. For example, a user can open dispenser panel 94a to access compartment 11 while leaving dispenser 94b closed.

The carton 5 could include various handle features for carrying the carton and could include various alternative dispenser features for opening the carton. Further the carton 5 could include other panel/flap closing configurations without departing from the disclosure.

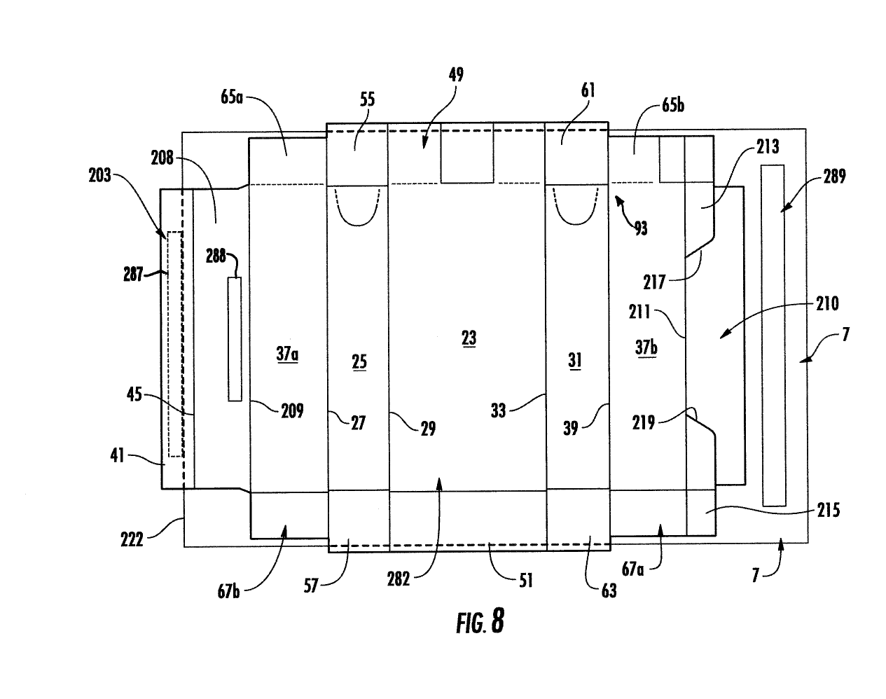

FIG. 8 shows a second embodiment of a blank 203 that forms a carton 205 of the second embodiment. The blank 203 and carton 205 are similar to the blank 3 and carton 5 of the first embodiment. Accordingly, similar or identical features of the embodiments are provided with like or similar reference numbers. The blank 203 includes first and second bottom panels 37a, 37b that cooperate to form a bottom panel 238 of the carton.

The blank 203 includes a first divider panel 208 foldably connected to the first bottom panel 37a at the fold line 209. In the embodiment of FIG. 8, the attachment flap 41 is foldably connected to the first divider panel 208 at the fold line 45.

In one embodiment, the blank 203 includes a second divider panel 210 foldably connected to the second bottom panel 37b at a fold line 211. The second bottom panel 37b includes two wings 213, 215 adjacent respective ends of the fold line 211. The wings 213, 215 are separated from the second divider panel 210 by respective cuts 217, 219.

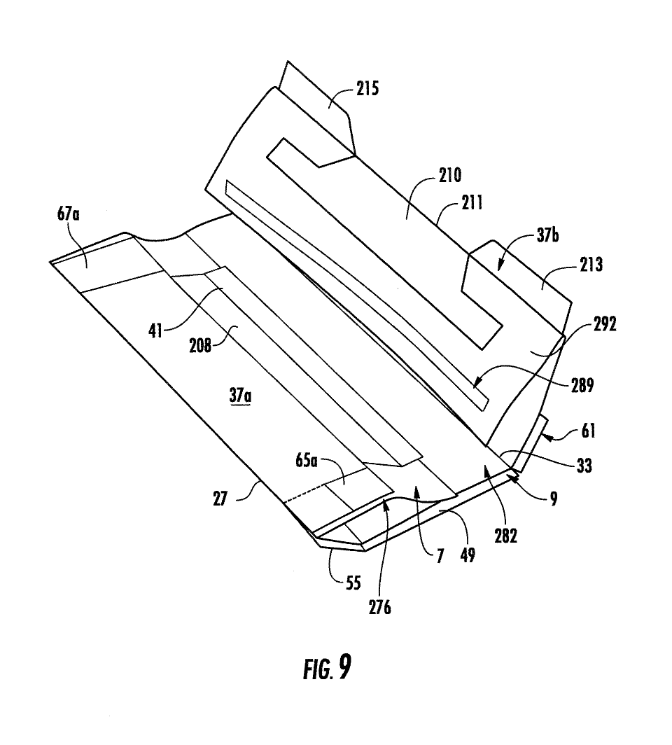

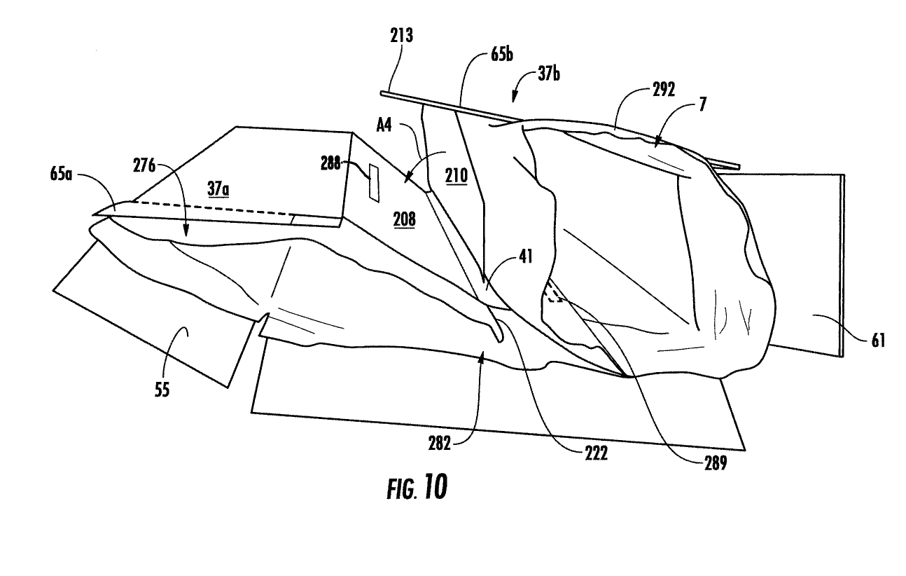

As shown in FIGS. 9-13B, the blank 203 can be assembled into the carton 205 in a similar manner as the first embodiment. The liner 7 can be attached to the interior surface 9 of the blank 203. As shown in FIG. 9, the first bottom panel 37a, the first divider panel 208, and the attachment flap 41 are folded relative to the first side panel 25 at fold line 27. In one embodiment, the attachment flap 41 and the first divider panel 208 can be attached to a portion 276 of the liner 7. As shown in FIGS. 8 and 10, the attachment flap 41 extends beyond the lateral edge 222 of the liner 7 and can be attached to a portion 282 of the liner that is in contact with the front panel 23 at an attachment region 287.

As shown in FIG. 9, the second bottom panel 37b and the second side panel 31 are upwardly folded at the fold line 33. The second divider panel 210 is downwardly folded at fold line 211. In the second embodiment, the liner 7 extends laterally beyond the edge of the second divider flap 210 and has an attachment region 289. As the second divider panel 210 is further positioned, the liner 7 and attachment region 289 are further positioned so that the attachment region is connected to the portion 282 of the liner in contact with the front panel 23.

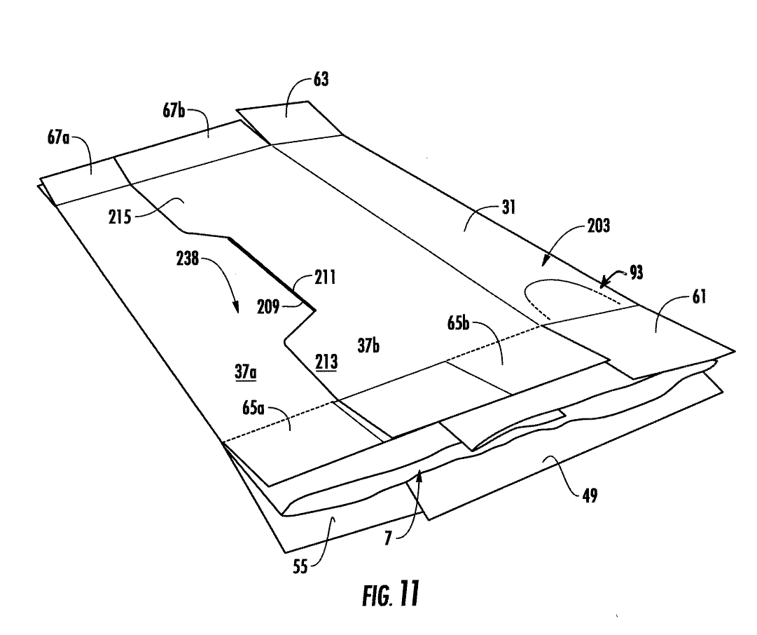

As shown in FIG. 10 the second divider panel 210 is brought into face-to-face contact with the first divider panel 208 by positioning in the direction of arrow A4. The divider panels 208, 210 can be secured together at an attachment region 288. As shown in FIG. 11, the wings 213, 215 of the second bottom panel 37b overlap and are secured to the exterior surface of the first bottom panel 37a. Also, the fold line 211 is generally adjacent to the fold line 209 and the first bottom panel 37a and second bottom panel 37b are secured together to form the bottom panel 238 of the carton 205.

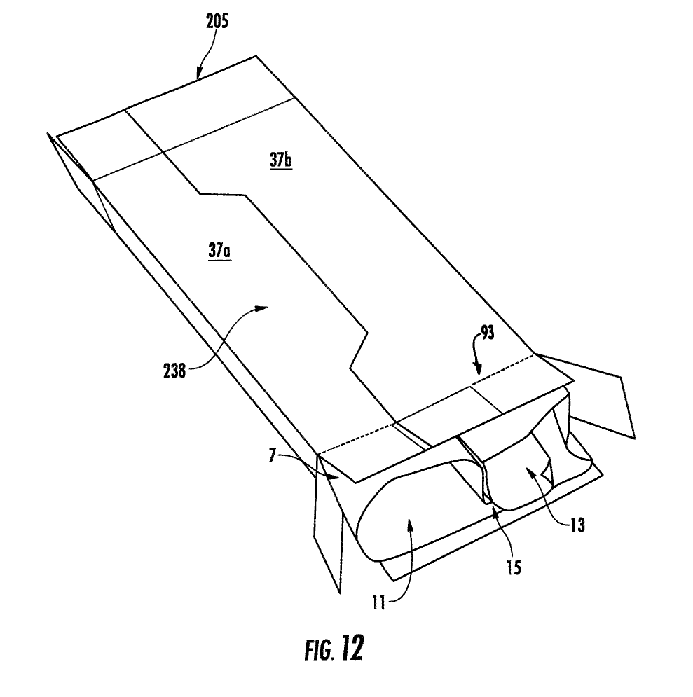

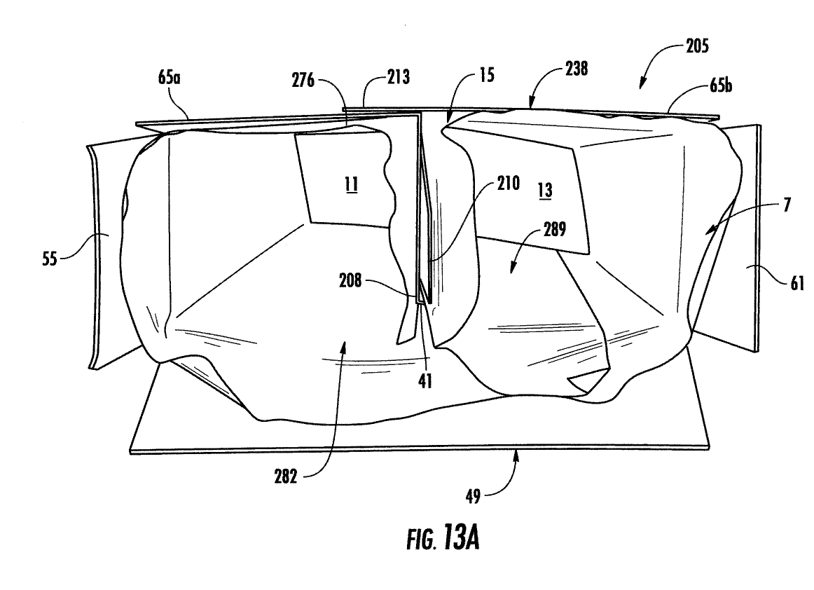

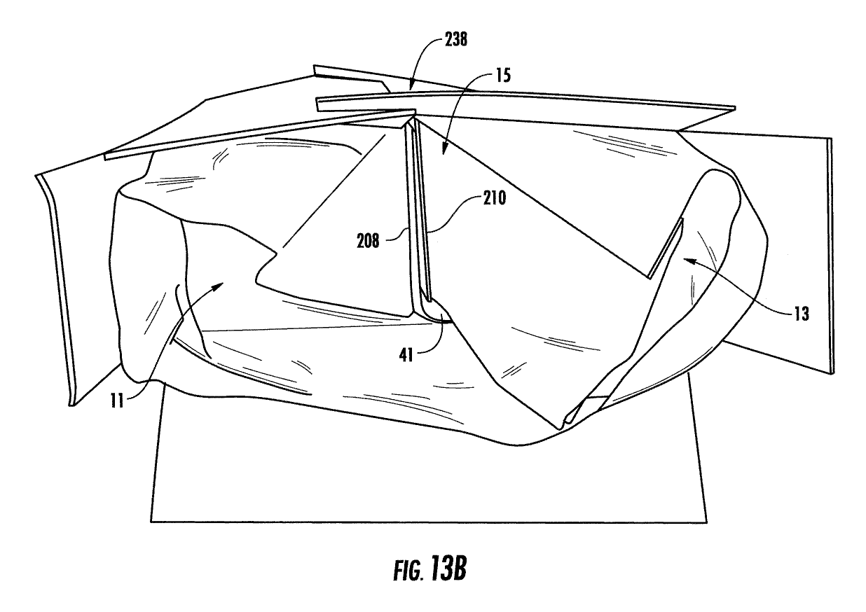

From the generally flat position of FIG. 11, the blank 203 is further assembled into the carton 205 by positioning the side panels 25, 31 so that the back panel 238 is spaced-apart from the front panel 23 (FIG. 12) and the two compartments 11, 13 of the carton 205 are formed. As shown in FIGS. 12, 13A, and 13B, the two compartments 11, 13 are separated by the divider 15 that comprises the first divider panel 208 and the second divider panel 210 in generally face-to-face contact. Also, the divider 15 comprises a portion of the liner 7 that is in contact with the first divider panel 208 and a portion of the liner that is in contact with the second divider panel 210. Each of the compartments 11, 13 are surrounded on all sides by the interior surface of the liner 7 (e.g., a surface that includes a metallization layer) to preserve freshness of the products held therein.

As with the previous embodiments, the carton 205 can be formed by other positioning methods. Further, the carton 205 can have other features (e.g., alternative dispenser features, handle features, etc.) without departing from the scope of this disclosure.

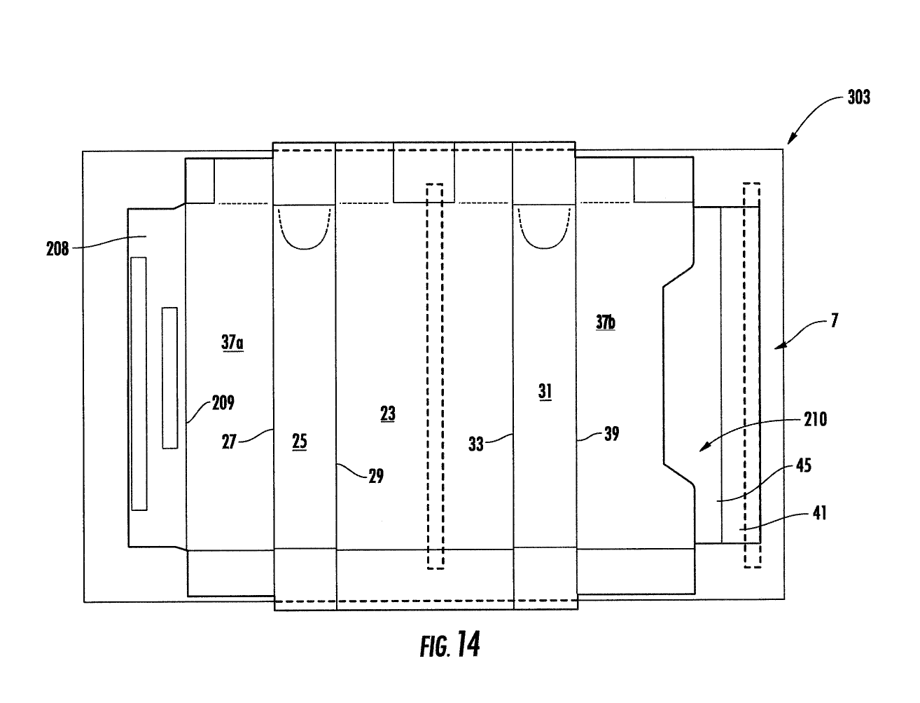

FIG. 14 shows a third embodiment of a blank 303 for forming a carton (not shown) of the second embodiment. The blank 203 and carton formed thereby are similar to the blank 203 and carton 205 of the second embodiment. Accordingly, similar or identical features of the embodiments are provided with like or similar reference numbers. The blank 303 includes the liner attachment flap 45 foldably connected to the second divider panel 210 at the fold line 45. The blank 303 is assembled into a carton in a similar manner as described above for the second embodiment.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank., In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding a plurality of articles, the carton comprising:
a plurality of panels that at least partially form an interior of the carton, the plurality of panels comprising a front panel, a back panel, and at least two side panels;
a liner at least partially attached to an interior surface of the carton; and
at least two compartments that are separated by at least a portion of the liner.

2. The carton of claim 1, wherein the liner comprises a first liner portion overlaying at least a portion of the front panel, a second liner portion overlaying at least a portion of the back panel, and a third liner portion.

3. The carton of claim 2, wherein the first liner portion comprises a first attachment region, the second liner portion comprises a second attachment region, and the third liner portion is attached to the first attachment region and the second attachment region.

4. The carton of claim 3, wherein at least a portion of the third liner portion extends generally perpendicularly to the front panel.

5. The carton of claim 3, wherein the third liner portion is attached to the first attachment region at an edge margin of the third liner portion.

6. The carton of claim 3, further comprising an attachment flap foldably attached to one of the at least two side panels, wherein the attachment flap is adhered to the back panel.

7. The carton of claim 1, wherein the plurality of panels comprise at least one divider panel at least partially separating the at least two compartments of the carton.

8. The carton of claim 7, wherein the back panel is a first back panel foldably connected to one of the at least two side panels and the plurality of panels comprises a second back panel foldably connected to the another one of the at least two side panels, and wherein the at least one divider panel comprises a first divider panel foldably connected to the first back panel.

9. The carton of claim 8, further comprising an attachment flap foldably connected to the first divider panel and adhered to a first liner portion overlaying at least a portion of the front panel.

10. The carton of claim 8, wherein the liner comprises a first liner portion overlaying at least a portion of the front panel, a second liner portion overlaying at least a portion of the second back panel, and a third liner portion overlaying at least a portion of the first back panel and the first divider panel.

11. The carton of claim 10, wherein the second liner portion comprises an attachment region attached to the first liner portion.

12. The carton of claim 10, wherein the at least one divider panel further comprises a second divider panel foldably connected to the second back panel and at least partially in face-to-face contact with the first divider panel.

13. The carton of claim 12, wherein the second liner portion overlays at least a portion of the second divider panel.

14. The carton of claim 12, wherein the second back panel comprises at least one wing at least partially in face-to-face contact with and adhered to the first back panel.

15. The carton of claim 14, wherein the at least one wing comprises a first wing and a second wing, and wherein the second divider panel is connected to the second back panel at a lateral fold line that at least partially extends between the first wing and the second wing.

16. The carton of claim 12, further comprising an attachment flap foldably connected to the second divider panel and adhered to the first liner portion.

17. The carton of claim 1, further comprising at least two end flaps respectively foldably connected to respective panels of the plurality of panels, wherein the end flaps are overlapped with respect to one another and thereby at least partially form a closed end of the carton, the at least two end flaps comprise a front end flap foldably connected to the front panel.

18. The carton of claim 17, further comprising a dispenser comprising a tear pattern extending in at least the front end flap and the first side panel, the tear pattern comprising at least a fold line extending in the front end flap and at least one tear line.

19. The carton of claim 18, wherein the at least two end flaps further comprises a back end flap foldably connected to the back panel, and wherein the tear pattern further extends in the back end flap.

20. A blank for forming a carton for containing a plurality of articles, the blank comprising:
a plurality of panels comprising a front panel, a back panel, and at least two side panels;
a liner at least partially attached to an interior surface of the blank for at least partially forming at least two compartments that are separated by at least a portion of the liner when the blank is formed into the carton.

21. The blank of claim 20, wherein the liner comprises a first liner portion overlaying at least a portion of the front panel, a second liner portion overlaying at least a portion of the back panel, and a third liner portion.

22. The blank of claim 21, wherein the first liner portion comprises a first attachment region, the second liner portion comprises a second attachment region, and the third liner portion is for being attached to the first attachment region and the second attachment region.

23. The blank of claim 22, wherein at least a portion of the third liner portion extends beyond a laterally-extending edge of the plurality of panels.

24. The blank of claim 22, wherein the third liner portion comprises an edge margin for being attached to the first attachment region.

25. The blank of claim 22, further comprising an attachment flap foldably attached to one of the at least two side panels, wherein the attachment flap is for being secured to the back panel.

26. The blank of claim 20, wherein the plurality of panels comprise at least one divider panel for at least partially separating the at least two compartments of the carton formed from the blank.

27. The blank of claim 26, wherein the back panel is a first back panel foldably connected to one of the at least two side panels and the plurality of panels comprises a second back panel foldably connected to the another one of the at least two side panels, and wherein the at least one divider panel comprises a first divider panel foldably connected to the first back panel.

28. The blank of claim 27, further comprising an attachment flap foldably connected to the first divider panel, wherein the attachment flap is for being secured to a first liner portion overlaying at least a portion of the front panel.

29. The blank of claim 27, wherein the liner comprises a first liner portion overlaying at least a portion of the front panel, a second liner portion overlaying at least a portion of the second back panel, and a third liner portion overlaying at least a portion of the first back panel and the first divider panel.

30. The blank of claim 29, wherein the at least one divider panel further comprises a second divider panel foldably connected to the second back panel, wherein the second liner portion overlays at least a portion of the second divider panel, and wherein the second divider panel is for being at least partially secured in face-to-face contact with the first divider panel.

31. The blank of claim 30, wherein the second back panel comprises a first wing and a second wing, and wherein the second divider panel is connected to the second back panel at a lateral fold line that at least partially extends between the first wing and the second wing.

32. The blank of claim 30, further comprising an attachment flap foldably connected to the second divider panel, wherein the attachment flap is for being secured to the first liner portion.

33. The blank of claim 20, further comprising:
at least two end flaps respectively foldably connected to respective panels of the plurality of panels, wherein the end flaps are overlapped with respect to one another and thereby at least partially form a closed end of the carton formed from the blank, the at least two end flaps comprise a front end flap foldably connected to the front panel; and
a dispenser comprising a tear pattern extending in at least the front end flap and the first side panel, the tear pattern comprising at least a fold line extending in the front end flap and at least one tear line.

34. A method of forming a carton from a blank, the method comprising:
obtaining a blank comprising a plurality of panels comprising a front panel, a back panel, and at least two side panels, and a liner at least partially attached to an interior surface of the blank; and
forming a divider that separates at least two compartments of the carton, the divider comprising at least a portion of the liner.

35. The method of claim 34, further comprising positioning the plurality of panels to form an interior of the carton, wherein the divider extends in the interior of the carton.

36. The method of claim 35, wherein the liner comprises a first liner portion overlaying at least a portion of the front panel, a second liner portion overlaying at least a portion of the back panel, and a third liner portion, wherein the first liner portion comprises a first attachment region and the second liner portion comprises a second attachment region, and wherein the forming the divider comprises securing the third liner portion to the first attachment region and the second attachment region.

37. The method of claim 36, wherein the blank further comprises an attachment flap foldably attached to one of the at least two side panels, and the positioning the plurality of panels further comprises securing the attachment flap to the back panel.

38. The method of claim 35, wherein the back panel is a first back panel foldably connected to one of the at least two side panels and the plurality of panels comprises a second back panel foldably connected to the another one of the at least two side panels, a first divider panel foldably connected to the first back panel, and a second divider panel foldably connected to the second back panel, and wherein the positioning the plurality of panels further comprises securing the second divider panel at least partially in face-to-face contact with the first divider panel.

39. The method of claim 38, wherein the liner comprises a first liner portion overlaying at least a portion of the front panel, a second liner portion overlaying at least a portion of the second back panel and the second divider panel, and a third liner portion overlaying at least a portion of the first back panel and the first divider panel, wherein the second liner portion comprises an attachment region, and wherein the forming the divider further comprises securing the attachment region to the first liner portion,

40. The method of claim 35, wherein the blank further comprises at least two end flaps respectively foldably connected to respective panels of the plurality of panels the at least two end flaps comprise a front end flap foldably connected to the front panel, wherein the method further comprises forming an at least partially closed end of the carton by overlapping the end flaps with respect to one another.
